(19) United States
(12) Patent Application Publication
(10) Pub. No.: US 2016/0290874 A1
(43) Pub. Date: Oct. 6, 2016

(54) TEMPERATURE SENSOR

(71) Applicant: MITSUBISHI MATERIALS CORPORATION, Tokyo (JP)

(72) Inventors: Noriaki Nagatomo, Naka-shi (JP); Masami Koshimura, Tokyo (JP); Keiji Shirata, Naka-shi (JP)

(21) Appl. No.: 14/778,030

(22) PCT Filed: Feb. 13, 2014
(86) PCT No.: PCT/JP2014/053961

§ 371 Date: Sep. 17, 2015

(30) Foreign Application Priority Data
Mar. 21, 2013 (JP) 2013-058093

(51) Int. Cl. G01K 7/22; H01C 7/00

(52) U.S. Cl. CPC G01K 7/223; H01C 7/008; H01C 7/006

(57) ABSTRACT

A temperature sensor is provided that includes a pair of lead frames; a sensor portion connected to the pair of lead frames; and an insulating holding portion fixed to the pair of lead frames for holding the same. The sensor portion includes an insulating film, a thin film thermistor portion patterned on a surface of the insulating film, a pair of comb shaped electrodes having a plurality of comb portions on the thin film thermistor portion and being patterned, and a pair of pattern electrodes patterned on the surface of the insulating film with one end thereof being connected to the pair of comb shaped electrodes and the other end thereof being connected to the pair of lead frames. The lead frame has a main lead portion and a base-end-side bonding portion. Only one of the pair of lead frames has a front-end-side bonding portion.

### BACKGROUND OF THE INVENTION

1. Field of the Invention

The present invention relates to a temperature sensor that is suitable for measuring a temperature of a heated roller used in a copying machine, a printer, or the like.

2. Description of the Related Art

In general, a temperature sensor is provided for use in contact with a heated roller in a copying machine or a printer in order to measure the temperature of the roller. Such a temperature sensor is disclosed in, for example, Patent documents 1 and 2, which include a pair of lead frames, a heat sensitive element that is arranged and connected between these lead frames, a holding portion that is formed at an end of the pair of lead frames, and a thin film sheet that is arranged so as to contact with the heated roller at one side of the lead frames and of the heat sensitive element.

Such a temperature sensor is contacted with the surface of the heated roller using the elastic force of the lead frames so as to detect a temperature.

The temperature sensor disclosed in Patent document 1 employs a bead or chip thermistor as a heat sensitive element, whereas the temperature sensor disclosed in Patent document 2 employs a thin film thermistor as a heat sensitive element in which a heat-sensitive film is formed over an insulating substrate made of alumina or the like. This thin film thermistor is constituted by the heat-sensitive film that is formed over the insulating substrate, a pair of lead portions for connecting the heat-sensitive film and the pair of lead frames, and a protective film for covering the heat-sensitive film.

### PRIOR ART DOCUMENTS

### Patent Documents

[Patent Document 1] Japanese Examined Patent Application No. H6-29793

[Patent Document 2] Japanese Patent Application Laid-Open No. 2000-74752

[Patent Document 3] Japanese Patent Application Laid-Open No. 2004-319737

### SUMMARY OF THE INVENTION

### Problems to be Solved by the Invention

The following problems still remain in the conventional technologies described above.

Specifically, the technology disclosed in Patent document 1, in which a bead thermistor or the like is used as a heat sensitive element, has a problem in that it is difficult to detect a correct temperature because the bead thermistor, which has a spherical or ellipsoidal shape of about 1 mm in this case, makes a point contact with a heated roller. Additionally, the heat sensitive element disadvantageously has a relatively large volume, which may cause the responsivity to be lowered. Furthermore, the point contact may damage the surface of the rotating roller.

In contrast, the technology disclosed in Patent document 2, which employs a thin film thermistor as a heat sensitive element, has a problem in that although it can make a plane contact with a heated roller, it still has a large volume when an insulating substrate and a lead portion that constitute the thin film thermistor are included, and this may cause the responsivity to be lowered.

The present invention has been made in view of the aforementioned circumstances, and an object of the present invention is to provide a temperature sensor which has a high precision and an excellent responsivity as well as not being easily twisted when a temperature is detected by pressing it onto a heated roller or the like.

### Means for Solving the Problems

The present invention adopts the following configuration in order to overcome the aforementioned problems. Specifically, a temperature sensor according to a first aspect of the present invention comprises a pair of lead frames; a sensor portion connected to the pair of lead frames; and an insulating holding portion that is fixed to the pair of lead frames for holding the same, wherein the sensor portion includes an insulating film in a band shape, a thin film thermistor portion that is patterned on a surface of the insulating film by a thermistor material, a pair of comb shaped electrodes that has a plurality of comb portions at least either on or under the thin film thermistor portion and is patterned so as to be opposed to each other, and a pair of pattern electrodes that is patterned on the surface of the insulating film with one end thereof being connected to the pair of comb shaped electrodes and the other end thereof being connected to the pair of lead frames, wherein the lead frame has a main lead portion extending along the insulating film and a base-end-side bonding portion that extends from the base end side of the main lead portion to the base end of the insulating film so as to bond to the base end, and wherein only one of the pair of lead frames has a front-end-side bonding portion that extends from the front end side of the main lead portion to the front end of the insulating film so as to bond to the front end.

Since only one of the pair of lead frames has the base-end-side bonding portion and the front-end-side bonding portion that extends from the front end side of the main lead portion to the front end of the insulating film so as to bond to the front end in this temperature sensor, the both ends of the insulating film can be fixed by one lead frame, thereby suppressing the sensor from being twisted as compared with the case where the both ends are fixed using two lead frames. In contrast, the other end of the pair of lead frames has only the base-end-side bonding portion, and thus the base-end-side bonding portion bonds to the base end of the insulating film but not to the front end thereof.

Furthermore, since the thin film thermistor portion is directly formed on the insulating film, the overall thickness of the sensor is reduced and the volume is reduced, whereby an excellent responsivity can be obtained. Additionally, since the pair of lead frames is connected to the pair of pattern electrodes, the thin film thermistor portion and the lead frames are connected through the pattern electrodes that are directly formed on the insulating film. Due to such a thin wiring portion that is patterned, the influence of the thermal conductivity at the lead frame side can be suppressed as compared with the case where the elements are connected with a lead wire or the like. Moreover, since the portion in contact with an object to be measured has high flatness for making plane contact, a correct temperature can be detected, and the surface of an object to be measured, such as a rotating heated roller, is not easily damaged.

A temperature sensor according to a second aspect of the present invention is characterized by the temperature sensor according to the first aspect, wherein the base-end-side bonding portion is housed in the holding portion.

That is, since the base-end-side bonding portion is housed in the holding portion, that is, since it can be held in the holding portion in this temperature sensor, the bondability becomes high and the reliability can be improved.

A temperature sensor according to a third aspect of the present invention is characterized in that the temperature sensor according to first or second aspect includes a pair of insulating protective sheets that is adhered to the front and back surfaces of the insulating film while covering the pair of lead frames.

That is, since the pair of protective sheets is adhered to the front and back surfaces of the insulating film so as to cover the pair of lead frames in this temperature sensor, the pair of lead frames can be stably held by the protective sheets, and the rigidity of the insulating film can be improved.

A temperature sensor according to a fourth aspect of the present invention is characterized by the temperature sensor according to any one of the first to third aspects, wherein the thin film thermistor portion is arranged near the front end of the insulating film, the pattern electrodes extend to the vicinity of the base end of the insulating film, and the base-end-side bonding portions of the pair of lead frames are connected to the pattern electrodes near the base end of the insulating film.

That is, the base-end-side bonding portions of the pair of lead frames are connected to the pattern electrodes near the base end of the insulating film in this temperature sensor, the thermal conduction to the lead frames can be suppressed by the long pattern electrodes, thereby improving the responsivity.

A temperature sensor according to a fifth aspect of the present invention is characterized by the temperature sensor according to any one of the first to fourth aspects, wherein the thin film thermistor portion is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal wurtzite-type single phase.

In general, a thermistor material used for a temperature sensor or the like needs to have a high B constant in order to provide a high precision and high sensitivity temperature sensor. Conventionally, transition metal oxides such as Mn, Co, Fe, and the like are typically used as such thermistor materials. These thermistor materials also need firing at a temperature of 600° C. or higher in order to obtain a stable thermistor characteristic/property.

In addition to thermistor materials consisting of metal oxides as described above, Patent Document 3 discloses a thermistor material consisting of a nitride represented by the general formula: MₓA_{y}N_{z} (where “M” represents at least one of Ta, Nb, Cr, Ti, and Zr, “A” represents at least one of Al, Si, and B, 0.1≦x≦0.8, 0<y≦0.6, 0.1≦z≦0.8, and x+y+z=1). In Patent Document 3, only a Ta—Al—N-based material consisting of a nitride represented by the general formula: MₓA_{y}N_{z} (where 0.5≦x≦0.8, 0.1≦y≦0.5, 0.2≦z≦0.7, and x+y+z=1) is described in an Example. The Ta—Al—N-based material is produced by sputtering in a nitrogen gas-containing atmosphere using a material containing the element(s) listed above as a target. The resultant thin film is subject to a heat treatment at a temperature from 350 to 600° C. as required.

In recent years, the development of a film type thermistor sensor made of a thermistor material formed on a resin film has been investigated, and thus, it has been desired to develop a thermistor material that can be directly deposited on a film. That is, it is expected that a flexible thermistor sensor will be obtained by using a film. Furthermore, it is desired to develop a very thin thermistor sensor having a thickness of about 0.1 mm. Although a substrate material using a ceramic material such as alumina that has often been conventionally used has the problem that if the substrate material is thinned to a thickness of 0.1 mm for example, the substrate material is very fragile and breaks easily, it is expected that a very thin thermistor sensor will be obtained by using a film.

Conventionally, when a temperature sensor made of a nitride-based thermistor material consisting of Ti—Al—N is formed by stacking a thermistor material layer consisting of Ti—Al—N and an electrode layer on a film, the electrode layer made of Au or the like is deposited on the thermistor material layer, and then the deposited film is patterned into a comb shape including a plurality of comb portions. When this thermistor material layer is gently bent with a large radius of curvature, a crack does not readily occur and the electric properties such as a resistance value or the like do not change, whereas when it is sharply bent with a small radius of curvature, a crack readily occurs and the resistance value or the like greatly changes, which may cause the reliability of the electric properties to be lowered. In particular, when the film is sharply bent in a direction orthogonal to the extending direction of the comb portions with a small radius of curvature, a crack readily occurs near the edge of the electrode due to the stress difference between the comb shaped electrode and the thermistor material layer as compared with the case where it is bent in the extending direction of the comb portions, which may disadvantageously cause the reliability of the electric properties to be lowered.

In addition, a film made of a resin material typically has a low heat resistance temperature of 150° C. or lower, and even polyimide, which is known as a material having a relatively high heat resistance temperature, only has a heat resistance to a temperature of about 300° C. Hence, when a heat treatment is performed in a process of forming a thermistor material, it has been conventionally difficult to apply such a thermistor material. Therefore, since the above-described conventional oxide thermistor material needs to be fired at a temperature of 600° C. or higher in order to realize a desired thermistor characteristic, a film type thermistor sensor in which thermistor material is directly deposited on a film cannot be realized by such a thermistor material. Thus, it has been desired to develop a thermistor material that can be directly deposited on a film without firing. However, even the thermistor material disclosed in Patent Document 3 still needs a heat treatment on the resultant thin film at a temperature from 350 to 600° C. as required in order to obtain a desired thermistor characteristic. Regarding this thermistor material, a B constant of about 500 to 3000 K was obtained in an Example of the Ta—Al—N-based material, but the heat resistance of this material is not described and therefore, thermal reliability of a nitride-based material is unknown.

The present inventors' serious endeavor carried out by focusing on an Al—N-based material among nitride materials found that the Al—N-based material having a good B constant and a high heat resistance may be obtained without firing by substituting the Al site with a specific metal element for improving electric conductivity and by ordering it into a specific crystal structure even though Al—N is an insulator and difficult to provide with an optimum thermistor characteristic (B constant: about 1000 to 6000 K).

Therefore, the present invention has been made on the basis of the above finding that when the thin film thermistor portion is made of a material consisting of a metal nitride represented by the general formula: TiₓAl_{y}N (where 0.70≦y/(x+y)≦0.95, 0.4≦z≦0.5, and x+y+z=1), wherein the crystal structure thereof is a hexagonal wurtzite-type single phase, a good B constant and a high heat resistance can be obtained without firing.

Note that when the value of “y/(x+y)” (i.e., Al/(Ti+Al)) is less than 0.70, a wurtzite-type single phase cannot be obtained, but two coexisting phases of a wurtzite-type phase and a NaCl-type phase or a single phase of only a NaCl-type phase may be obtained. Consequently, a sufficiently high resistance and a high B constant cannot be obtained.

When the value of “y/(x+y)” (i.e., Al/(Ti+Al)) exceeds 0.95, the metal nitride exhibits very high resistivity and extremely high electrical insulation. Therefore, such a metal nitride is not applicable as a thermistor material.

When the value of “z” (i.e., N/(Ti+A+N)) is less than 0.4, the amount of nitrogen contained in the metal is too small to obtain a wurtzite-type single phase. Consequently, a sufficiently high resistance and a high B constant cannot be obtained.

Furthermore, when the value of “z” (i.e., N/(Ti+Al+N)) exceeds 0.5, a wurtzite-type single phase cannot be obtained. This is because the stoichiometric ratio of N/(Ti+Al+N) in a wurtzite-type single phase without defects at the nitrogen site is 0.5.

### Effects of the Invention

According to the present invention, the following effects may be provided.

Specifically, according to the temperature sensor of the present invention, since only one of the pair of lead frames has the base-end-side bonding portion and the front-end-side bonding portion that extends from the front end side of the main lead portion to the front end of the insulating film so as to bond to the front end, the both ends of the insulating film can be fixed by one lead frame, thereby suppressing the sensor from being twisted as compared with the case where the both ends are fixed by two lead frames.

Further, since the thin film thermistor portion and the lead frames are connected through the pattern electrodes that are directly formed on the insulating film, an excellent responsivity can be obtained and a correct temperature can be measured using such a thin film thermistor portion and such thin pattern electrodes, which are directly formed on the thin insulating film.

Furthermore, when the thin film thermistor portion is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal wurtzite-type single phase, a good B constant and a high heat resistance can be obtained without firing.

Therefore, the temperature sensor of the present invention is suitable for measuring a temperature of a heated roller used in a copying machine, a printer, or the like since it allows a stable plane contact by the sensor portion of which twisting is suppressed, and can measure a correct temperature with a high responsivity.

### BRIEF DESCRIPTION OF THE DRAWINGS

FIG. 1 is plan and front views illustrating a temperature sensor according to one embodiment of the present invention.

FIG. 2 is a Ti—Al—N-based ternary phase diagram illustrating the composition range of a metal nitride material for a thermistor according to the present embodiment.

FIG. 3 is a plan view and a cross-sectional view along line A-A illustrating a sensor portion according to the present embodiment.

FIG. 4 is a plan view and a cross-sectional view along line B-B illustrating a step for forming a thin film thermistor portion according to the present embodiment.

FIG. 5 is a plan view and a cross-sectional view along line C-C illustrating a step for forming electrodes according to the present embodiment.

FIG. 6 is plan and front views illustrating a step for attaching lead frames according to the present embodiment.

FIG. 7 is plan and front views illustrating a step for attaching protective sheets according to the present embodiment.

FIG. 8 is plan and front views illustrating a step for cutting lead frames according to the present embodiment.

FIG. 9 is plan and front views illustrating a step for connecting lead wires according to the present embodiment.

FIG. 10 is a front and plan views illustrating a film evaluation element made of a metal nitride material for a thermistor used in an Example of a temperature sensor according to the present invention.

FIG. 11 is a graph illustrating the relationship between a resistivity at 25° C. and a B constant for the materials according to Examples and Comparative Examples of the present invention.

FIG. 12 is a graph illustrating the relationship between an Al/(Ti+Al) ratio and a B constant for the materials according to Examples and Comparative Examples of the present invention.

FIG. 13 is a graph illustrating the result of X-ray diffraction (XRD) performed on a material according to the Example of the present invention having an Al/(Ti+Al)=0.84 and a strong c-axis orientation.

FIG. 14 is a graph illustrating the result of X-ray diffraction (XRD) performed on a material according to the Example of the present invention having an Al/(Ti+Al)=0.83 and a strong a-axis orientation.

FIG. 15 is a graph illustrating the result of X-ray diffraction (XRD) performed on a material according to the Comparative Example of the present invention having an Al/(Ti+Al)=0.60.

FIG. 16 is a graph illustrating the relationship between an Al/(Ti+Al) ratio and a B constant for the comparison of a material exhibiting a strong a-axis orientation and a material exhibiting a strong c-axis orientation according to Examples of the present invention.

FIG. 17 is a cross-sectional SEM photograph of a material exhibiting a strong c-axis orientation according to an Example of the present invention.

FIG. 18 is a cross-sectional SEM photograph of a material exhibiting a strong a-axis orientation according to an Example of the present invention.

### DESCRIPTION OF THE EMBODIMENTS

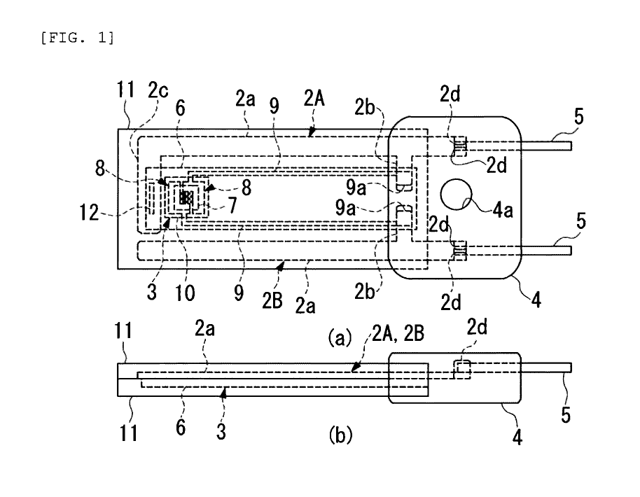

Hereinafter, a temperature sensor according to a first embodiment of the present invention will be described with reference to FIGS. 1 to 9. In the drawings used in the following description, the scale of each component is changed as appropriate so that each component is recognizable or is readily recognized.

As shown FIG. 1, a temperature sensor 1 of the present embodiment includes a pair of lead frames 2A, 2B, a sensor portion 3 that is connected to the pair of lead frames 2A, 2B, and an insulating holding portion 4 that is fixed to the pair of lead frames 2A, 2B for holding the same.

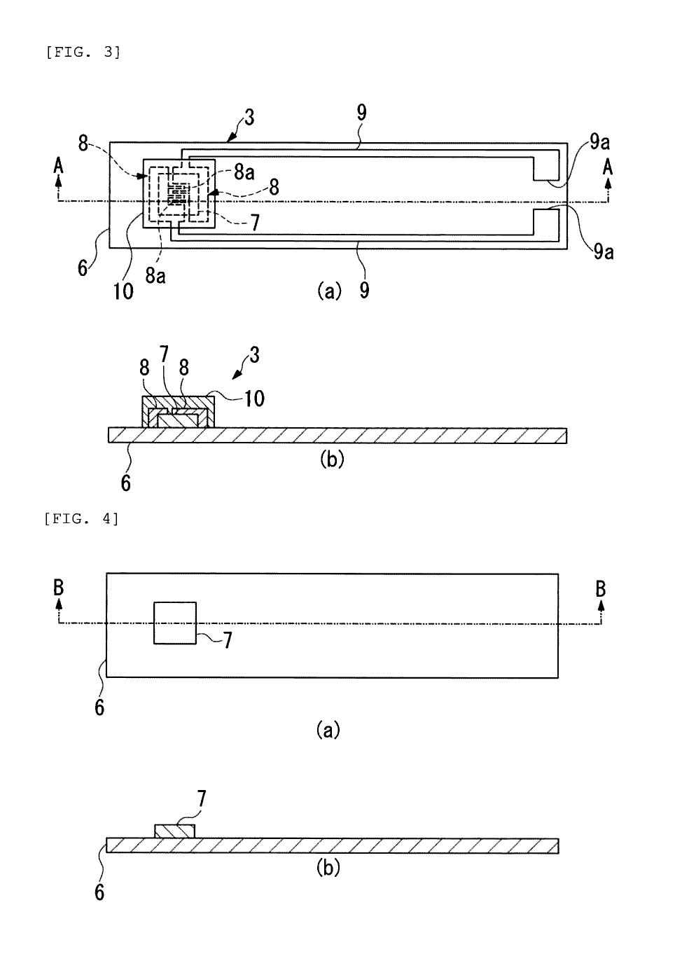

As shown in FIG. 3, the sensor portion 3 has an insulating film 6 in a band shape, a thin film thermistor portion 7 that is patterned on the surface of the insulating film 6 using a thermistor material, a pair of comb shaped electrodes 8 that has a plurality of comb portions 8a and is patterned on the thin film thermistor portion 7 so as to be opposed to each other, and a pair of pattern electrodes 9 that is patterned on the surface of the insulating film 6 with one end thereof being connected to the pair of comb shaped electrodes 8 and the other end thereof being connected to the pair of lead frames 2A, 2B.

The lead frames 2A, 2B have main lead portions 2a extending along the insulating film 6 and base-end-side bonding portions 2b that extend from the base end sides of the main lead portions 2a to the base end of the insulating film 6 so as to bond to the base end, wherein only one of the pair of lead frames 2A, 2B (lead frame 2A) has a front-end-side bonding portion 2c that extends from the front end side of the main lead portion 2a to the front end of the insulating film 6 so as to bond to the front end.

The front-end-side bonding portion 2c extends in a direction orthogonal to the main lead portions 2a and is adhered to an adhesion portion 12 with an adhesive or the like so as to cover the entire front end of the insulating film 6.

Additionally, the pair of base-end-side bonding portions 2b protrudes toward each other from a pair of main lead portions 2a that is arranged on the both sides of the insulating film 6, and is joined to the pair of pattern electrodes 9 by soldering or the like.

In contrast, the other of the pair of lead frames 2A, 2B (lead frame 2B) has only the base-end-side bonding portion 2b, and thus, it bonds to the base end of the insulating film 6 but not to the front end thereof.

The thin film thermistor portion 7 is arranged near the front end of the insulating film 6, and the pattern electrodes 9 extend to the vicinity of the base end of the insulating film 6. The pair of pattern electrodes 9 has a pair of adhesive pads 9a near the base end of the insulating film 6, and the pair of base-end-side bonding portions 2b is adhered and connected to the corresponding adhesive pads 9a with an adhesive (not shown) such as a conductive resin adhesive.

The pair of lead frames 2A and 2B is made of an alloy such as a copper-based alloy, an iron-based alloy, or stainless steel, and supported by the holding portion 4 made of a resin such that a fixed gap is maintained between each other. Additionally, the holding portion 4 has a mounting hole 4a formed therein.

The main lead portions 2a of the pair of lead frames 2A and 2B extend along the insulating film 6 over substantially the entire length thereof in the extending direction on both sides thereof.

Further, the base ends of the pair of lead frames 2A are 2B are connected to a pair of lead wires 5 within the holding portion 4. At the base ends of the lead frames 2A and 2B, a pair of fixing protrusions 2d is formed for fixing the tips of the lead wires 5 by pinching and caulking them.

Furthermore, the pair of base-end-side bonding portions 2b and the fixing protrusions 2d are housed in the holding portion 4. Specifically, the bonding portions between the sensor portion 3 and the lead frames 2A and 2B as well as the connecting portions between the lead frames 2A and 2B and the lead wires 5 are both housed in the holding portion 4.

The temperature sensor 1 of the present embodiment also includes a protective film 10 for covering the thin film thermistor portion 7 on the surface of the insulating film 6, and a pair of insulating protective sheets 11 that is adhered to the front and back surfaces of the insulating film 6 so as to cover the pair of lead frames 2A and 2B.

The protective film 10 is an insulating resin film or the like and, for example, a polyimide film having a thickness of 20 μm is employed. The protective film 10 is patterned to have a rectangular shape so as to cover the comb portions 8a together with the thin film thermistor portion 7.

The pair of protective sheets 11, which is a polyimide film or the like, is adhered to each other with an adhesive so as to sandwich the sensor portion 3 and the pair of lead frames 2A and 2B therebetween.

The insulating film 6 is a polyimide resin sheet formed in a band shape having a thickness of 7.5 to 125 μm for example. The insulating film 6 may be made of another material such as polyethylene terephthalate (PET), polyethylene naphthalate (PEN), or the like, but a polyimide film is preferably used for measuring a temperature of a heated roller since the maximum allowable working temperature is as high as 230° C.

The thin film thermistor portion 7 is arranged at one end of the insulating film 6, and made of a Ti—Al—N thermistor material. In particular, the thin film thermistor portion 7 is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal wurtzite-type single phase.

The pattern electrodes 9 and the comb shaped electrodes 8 have a Cr or NiCr bonding layer formed on the thin film thermistor portion 7 having a film thickness of 5 to 100 nm, and an electrode layer made of a noble metal such as Au having a film thickness of 50 to 1000 nm formed on the bonding layer.

The pair of comb shaped electrodes 8 is patterned so as to be opposed to each other and to have the comb portions 8a that are alternately arranged.

Note that the comb portions 8a extend along the extending direction of the insulating film 6 (the extending direction of the main lead portions 2a). When a temperature is measured by pressing the back side of the insulating film 6 onto a rotating heated roller, the thin film thermistor portion 7 is bent in the extending direction of the insulating film 6 with a curvature. Accordingly, a bending stress is also applied to the thin film thermistor portion 7 in the same direction. However, since the thin film thermistor portion 7 can be reinforced by the comb portions 8a that extend in the same direction, the occurrence of a crack can be suppressed.

As described above, the thin film thermistor portion 7 is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal crystal system and a wurtzite-type (space group: P6₃mc (No. 186)) single phase.

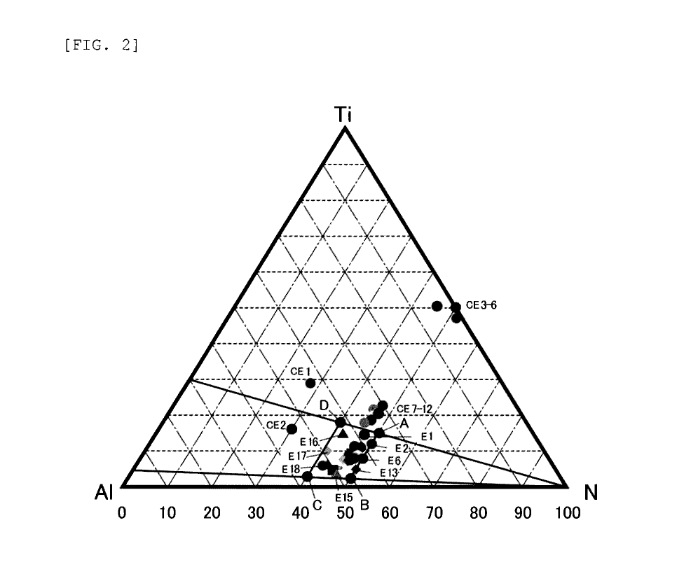

Specifically, this metal nitride material consists of a metal nitride which has a composition within the region enclosed by the points A, B, C, and D in the Ti—Al—N-based ternary phase diagram as shown in FIG. 2, wherein the crystal phase thereof is wurtzite-type.

Note that the composition ratios of (x, y, z) (at %) at the points A, B, C, and D are A (15, 35, 50), B (2.5, 47.5, 50), C (3, 57, 40), and D (18, 42, 40), respectively.

Also, the thin film thermistor portion 7 is deposited as a film having a film thickness of 100 to 1000 nm for example, and is a columnar crystal extending in a vertical direction with respect to the surface of the film. Furthermore, it is preferable that the material of the thin film thermistor portion 7 is more strongly oriented along the c-axis than the a-axis in a vertical direction with respect to the surface of the film.

Note that the decision about whether the material of the thin film thermistor portion 7 has a strong a-axis orientation (100) or a strong c-axis orientation (002) in a vertical direction with respect to the surface of the film (film thickness direction) is made by examining the orientation of the crystal axis using X-ray diffraction (XRD). When the peak intensity ratio of “the peak intensity of (100)”/“the peak intensity of (002)”, where (100) is the Miller index indicating a-axis orientation and (002) is the Miller index indicating c-axis orientation, is less than 1, the material of the thin film thermistor portion 7 is determined to have a strong c-axis orientation.

Next, a method for producing the temperature sensor 1 will be described below with reference to FIGS. 1, and 3 to 9.

The method for producing the temperature sensor 1 of the present embodiment includes a step for forming a thin film thermistor portion by patterning the thin film thermistor portion 7 on the insulating film 6, a step for forming an electrode by arranging the pair of comb shaped electrodes 8 that is opposed to each other on the thin film thermistor portion 7 and pattering the pair of pattern electrodes 9 on the insulating film 6, a step for forming a protective film by forming the protective film 10 on the surface of the thin film thermistor portion 7, a step for attaching a lead frame by attaching the lead frames 2A and 2B to the sensor portion 3, a step for adhering a sheet by adhering the pair of protective sheets 11 so as to sandwich the sensor portion 3 and the lead frames 2A and 2B therebetween and cover the same, a step for connecting the lead wires 5 to the lead frames 2A and 2B, and a step for attaching the holding portion 4 to the base end sides of the lead frames 2A and 2B.

In a more specific example of the method for producing the temperature sensor 1, a thermistor film made of a material consisting of TiₓAl_{y}N_{z} (where x=9, y=43, and z=48) having a film thickness of 200 nm is deposited on the insulating film 6 made of a polyimide film having a thickness of 50 μm by a reactive sputtering method in a nitrogen-containing atmosphere using a Ti—Al alloy sputtering target. The sputtering conditions at this time are as follows: an ultimate vacuum: 5×10−6 Pa, a sputtering gas pressure: 0.4 Pa, a target input power (output): 200 W, and a percentage of nitrogen gas in a mixed gas (Ar gas+nitrogen gas) atmosphere: 20%.

Next, patterning is performed as follows: after a resist solution is coated on the deposited thermistor film using a bar coater, pre-baking is performed for 1.5 minutes at a temperature of 110° C.; after exposure by an exposure device, any unnecessary portions are removed by a developing solution, and then post-baking is performed for 5 minutes at a temperature of 150° C. Then, any unnecessary portion of the TiₓAl_{y}N_{z} thermistor film is subject to wet etching using a commercially available Ti etchant, and then the resist is stripped so as to form the thin film thermistor portion 7 as desired, as shown in FIG. 4.

Next, a bonding layer made of a Cr film having a film thickness of 20 nm is formed on the thin film thermistor portion 7 and the insulating film 6 by a sputtering method. Furthermore, an electrode layer of an Au film having a film thickness of 100 nm is formed on this bonding layer by a sputtering method.

Next, patterning Is performed as follow: after a resist solution is coated on the deposited electrode layer using a bar coater, pre-baking is performed for 1.5 minutes at a temperature of 110° C.; after exposure by an exposure device, any unnecessary portion is removed by a developing solution, and then post-baking is performed for 5 minutes at a temperature of 150° C. Then, any unnecessary electrode portion is subject to wet etching using a commercially available Au etchant and Cr etchant in that order, and then the resist is stripped so as to form the comb shaped electrodes 8 and the pattern electrodes 9 as desired, as shown in FIG. 5.

Furthermore, a polyimide varnish is applied on the thin film thermistor portion 7 by a printing method and cured for 30 minutes at 250° C. so as to pattern a polyimide protective film 10 having a thickness of 20 m as shown in FIG. 3.

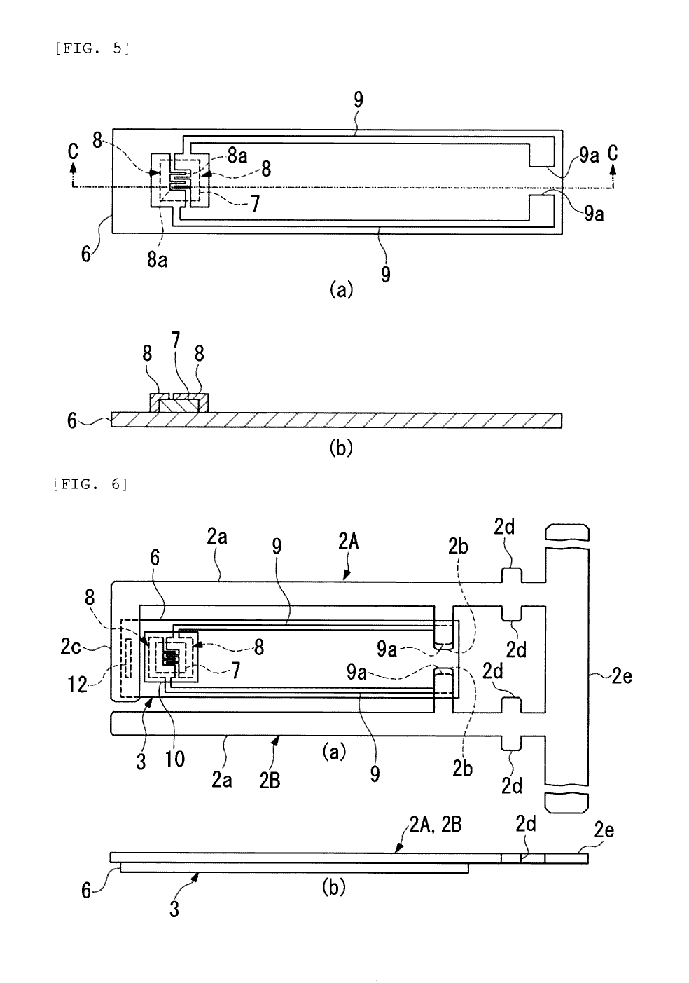

Next, the base-end-side bonding portions 2b of the pair of lead frames 2A and 2B are put on the adhesive pads 9a of the pattern electrodes 9, and the base-end-side bonding portions 2b and the adhesive pads 9a are joined by soldering, with a conductive resin adhesive, or by welding as shown in FIG. 6. At the same time, the front-end-side bonding portion 2c is arranged on the front end of the insulating film 6, and the front-end-side bonding portion 2c and the front end of the insulating film 6 are fixed at the adhesion portion 12 by soldering, welding, or with an adhesive. At this time, a plurality of pairs of lead frames 2A, 2B are coupled to each other at its base end side with a coupling portion 2e. Additionally, at the base end side of the lead frames 2A, 2B, the fixing protrusions 2d are formed so as to protrude from the both sides of the main lead portion 2a.

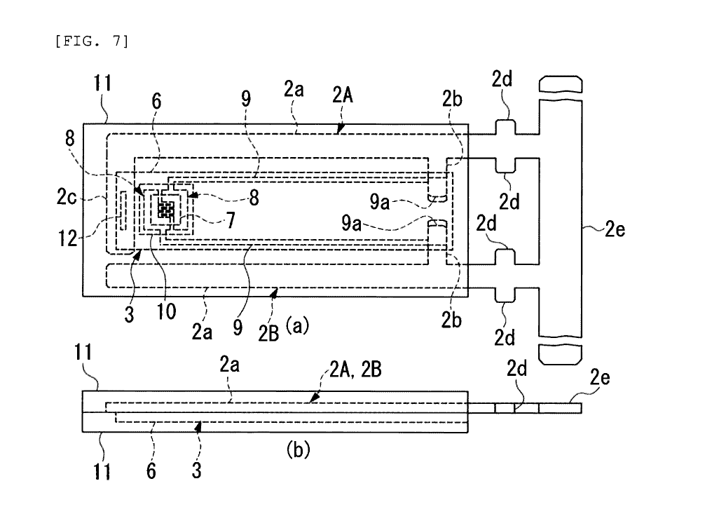

Next, as shown in FIG. 7, a pair of polyimide or Teflon® films serving as protective sheets 11 with an adhesive are adhered to the front and back surfaces of the insulating film 6 so as to sandwiched the sensor portion 3 and the lead frames 2A and 2B therebetween.

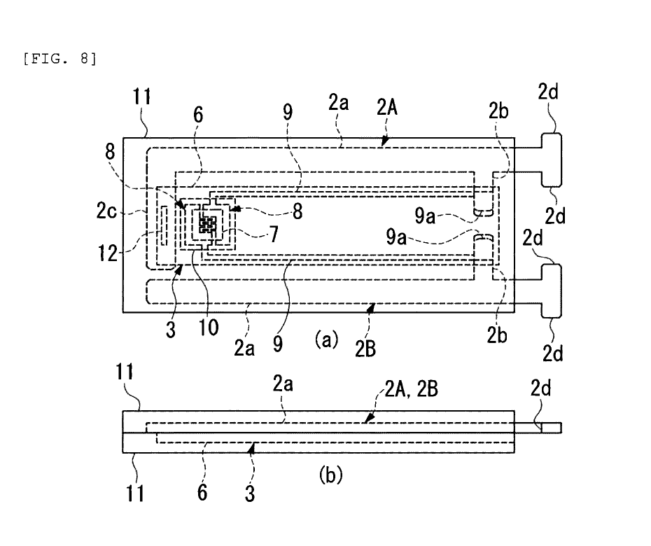

Furthermore, as shown in FIG. 8, each of a plurality of pairs of lead frames 2A and 2B that are adjacent to each other is cut away from the coupling portion 2e, which is for coupling the plurality of pairs lead frames 2A and 2B, at the base end side of the fixing protrusions 2d.

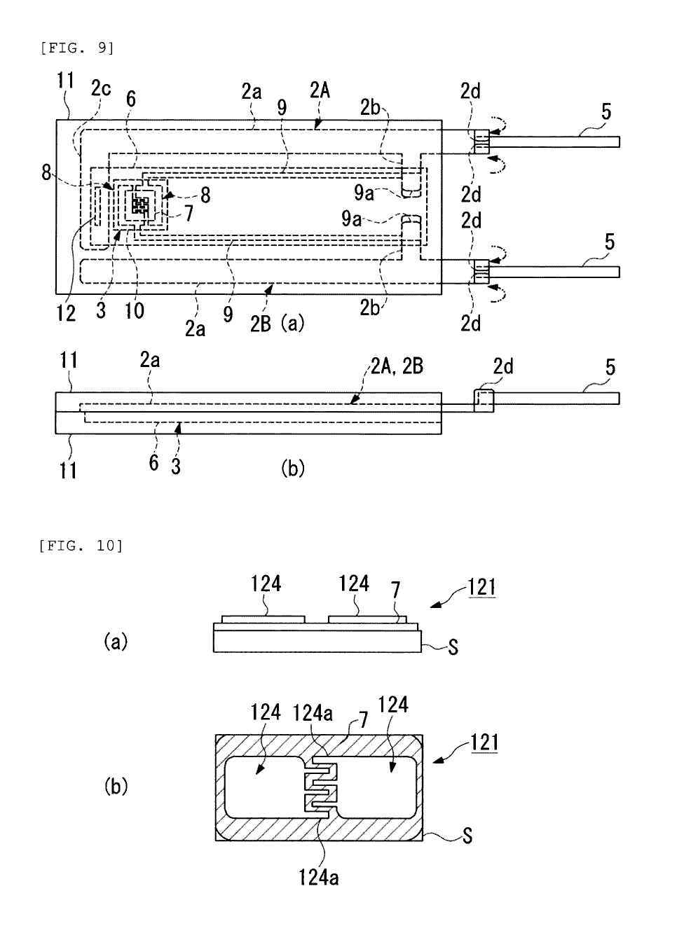

Next, as shown in FIG. 9, the pair of fixing protrusions 2d are folded inwardly toward each other so as to pinch and caulk the tips of the lead wires 5 while the tips of the lead wires 5 are arranged between the pair of fixing protrusions 2d (at the base ends of the main lead portions 2a), thereby fixing the tips of the lead wires 5 to the base ends of the lead frames 2A, 2B.

Finally, the holding portion 4 is resin-molded so as to house the bonding portions at the base-end-side bonding portions 2b and the connecting portions between the fixing protrusions 2d and the lead wires 5, thus producing the temperature sensor 1 of the present embodiment as shown in FIG. 1.

When a plurality of sensor portions 3 is simultaneously produced, a plurality of thin film thermistor portions 7, a plurality of comb shaped electrodes 8, a plurality of pattern electrodes 9, and a plurality of protective films 10 are formed on a large-format sheet of the insulating film 6 as described above, and then, the resulting large-format sheet is cut into a plurality of segments so as to obtain a plurality of sensor portions 3.

Thus, in the temperature sensor 1 of the present embodiment, since only one of the pair of lead frames 2A and 2B (lead frame 2A) has the base-end-side bonding portions 2b and the front-end-side bonding portion 2c that extends from the front end side of the main lead portion 2a to the front end of the insulating film so as to bond to the front end, both ends of the insulating film 6 can be fixed by one lead frame 2A, thereby suppressing the sensor from being twisted as compared with the case where the both ends are fixed by two lead frames.

With the thin film thermistor portion 7 which is directly formed on the insulating film 6, the overall thickness (or the volume) of the sensor can be reduced, whereby an excellent responsivity can be obtained. Additionally, since the pair of lead frames 2A and 2B are connected to the pair of pattern electrodes 9, the thin film thermistor portion 7 and the lead frames 2A and 2B are connected through the pattern electrodes 9 that is directly formed on the insulating film 6. Owing to such a thin wiring portion that is patterned, the influence of the thermal conductivity at the side of the lead frames 2A and 2B can be suppressed as compared with the case the elements are connected with a lead wire or the like. Note that the portion in contact with an object to be measured has high flatness to make a plane contact, a correct temperature can be detected as well as the surface of an object to be measured such as a rotating heated roller is not easily damaged.

Since the base-end-side bonding portions 2b are housed in the holding portion 4, that is, they can be held in the holding portion 4, the bondability becomes high and the reliability can be improved.

Additionally, since the pair of protective sheets 11 is adhered to the front and back surfaces of the insulating film 6 so as to cover the pair of lead frames 2A and 2B, the pair of lead frames 2A and 2B can be stably held by the protective sheets 11, and the rigidity of the insulating film 6 can be improved.

Furthermore, since the base-end-side bonding portions 2b of the pair of lead frames 2A and 2B are connected to the pattern electrodes 9 near the base end of the insulating film 6, the thermal conduction to the lead frames 2A and 2B can be suppressed by the long pattern electrode 9, thereby improving the responsivity.

Since the thin film thermistor portion 7 is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal crystal system and a wurtzite-type single phase, a good B constant and a high heat resistance can be obtained without firing.

Further, since this metal nitride material is a columnar crystal extending in a vertical direction with respect to the surface of the film, the crystallinity of the film is high. Consequently, a high heat resistance can be obtained.

Furthermore, since this metal nitride material is more strongly oriented along the c-axis than the a-axis in a vertical direction with respect to the surface of the film, a high B constant as compared with the case of a strong a-axis orientation can be obtained.

In the method for producing the thermistor material layer (thin film thermistor portion 7) of the present embodiment, since film deposition is performed by reactive sputtering in a nitrogen-containing atmosphere using a Ti—Al alloy sputtering target, the metal nitride material consisting of the aforementioned Ti—Al—N can be deposited on a film without firing.

In addition, when the sputtering gas pressure during the reactive sputtering is set to less than 0.67 Pa, a metal nitride material film, which is more strongly oriented along the c-axis than the a-axis in a vertical direction to the surface of the film, can be formed.

Thus, since the thin film thermistor portion 7 made of the above-described thermistor material layer is formed on the insulating film 6 in the temperature sensor 1 of the present embodiment, the insulating film 6 having a low heat resistance, such as a resin film, can be used because the thin film thermistor portion 7 is formed without firing and has a high B constant and a high heat resistance. Consequently, a thin and flexible thermistor sensor having a good thermistor characteristic can be obtained.

In addition, a substrate material employing a ceramic such as alumina that has often been conventionally used has a problem that if the substrate material is thinned to a thickness of 0.1 mm for example, the substrate material is very fragile and breaks easily. In contrast, since a film can be used in the present invention, the very thin film type thermistor sensor (sensor portion 3) having a thickness of 0.1 mm, for example, can be obtained as described above.

### Examples

Next, the evaluation results of the materials according to Examples produced based on the above embodiment regarding the temperature sensor according to the present invention will be specifically described with reference to FIGS. 10 to 18.

### <Production of Film Evaluation Element>

The film evaluation elements 121 shown in FIG. 10 are produced according to Examples and Comparative Examples for evaluating the thermistor material layer (thin film thermistor portion 7) of the present invention as follows.

Firstly, each of the thin film thermistor portions 7, which have a thickness of 500 nm and are made of the metal nitride materials with the various composition ratios shown in Table 1, is formed on an Si wafer with a thermal oxidation film as an Si substrate S by using Ti—Al alloy targets with various composition ratios by the reactive sputtering method. The thin film thermistor portions 7 are formed under the sputtering conditions of an ultimate vacuum of 5×10⁻⁶ Pa, a sputtering gas pressure of from 0.1 to 1 Pa, a target input power (output) of from 100 to 500 W, and a percentage of nitrogen gas in a mixed gas (Ar gas+nitrogen gas) atmosphere of from 10 to 100%.

Next, a Cr film having a thickness of 20 nm is formed and an Au film having a thickness of 100 nm is further formed on each of the thin film thermistor portions 7 by the sputtering method. Furthermore, patterning is performed as follows: a resist solution is coated on the stacked metal films using a spin coater, and then pre-baking is performed for 1.5 minutes at a temperature of 110° C.; after the exposure by an exposure device, any unnecessary portion is removed by a developing solution, and then post-baking is performed for 5 minutes at a temperature of 150° C. Then, any unnecessary electrode portions are subject to wet etching using commercially available Au etchant and Cr etchant, and then the resist is stripped so as to form a pair of pattern electrodes 124, each having desired comb shaped electrode portions 124a. Then, the resultant elements are diced into chip elements so as to obtain the film evaluation elements 121 used for evaluating a B constant and for testing heat resistance.

Note that the film evaluation elements 121 according to Comparative Examples, each having the composition ratio of TiₓAl_{y}N_{z} outside the range of the present invention and a different crystal system, are similarly produced for comparative evaluation.

### <Film Evaluation>

(1) Composition Analysis

Elemental analysis is performed by X-ray photoelectron spectroscopy (XPS) on the thin film thermistor portions 7 obtained by the reactive sputtering method. In the XPS, a quantitative analysis is performed on a sputtering surface at a depth of 20 nm from the outermost surface by Ar sputtering. The results are shown in Table 1. In the following tables, the composition ratios are expressed by “at %”.

In the X-ray photoelectron spectroscopy (XPS), a quantitative analysis is performed under the conditions of an X-ray source of MgKα (350 W), a path energy of 58.5 eV, a measurement interval of 0.125 eV, a photo-electron take-off angle with respect to a sample surface of 45 deg, and an analysis area of about 800 μmφ. Note that the quantitative precision of N/(Ti+Al+N) is ±2% and that of Al/(Ti+Al) is ±1%.

(2) Specific Resistance Measurement

The specific resistance of each of the thin film thermistor portions 7 obtained by the reactive sputtering method is measured by the four-probe method at a temperature of 25° C. The results are shown in Table 1.

(3) Measurement of B Constant

The resistance values for each of the film evaluation elements 121 at temperatures of 25° C. and 50° C. are measured in a constant temperature bath, and a B constant is calculated based on the resistance values at temperatures of 25° C. and 50° C. The results are shown in Table 1.

In the B constant calculating method of the present invention, a B constant is calculated by the following formula using the resistance values at temperatures of 25° C. and 50° C. as described above.

B constant(K)=ln(R25/R50)/(1/T25−1/T50)

R25 (Ω): resistance value at 25° C.

R50 (Ω): resistance value at 50° C.

T25 (K): 298.15 K, which is an absolute temperature of 25° C. expressed in Kelvin

T50 (K): 323.15 K, which is an absolute temperature of 50° C. expressed in Kelvin

As can be seen from these results, a thermistor characteristic having a resistivity of 100 Ωcm or higher and a B constant of 1500 K or higher is achieved in all of the Examples in which the composition ratios of TiₓAl_{y}N_{z} fall within the region enclosed by the points A, B, C, and D in the ternary phase diagram shown in FIG. 2, i.e., the region where “0.70≦y/(x+y)≦0.95, 0.4≦z≦0.5, and x+y+z=1”.

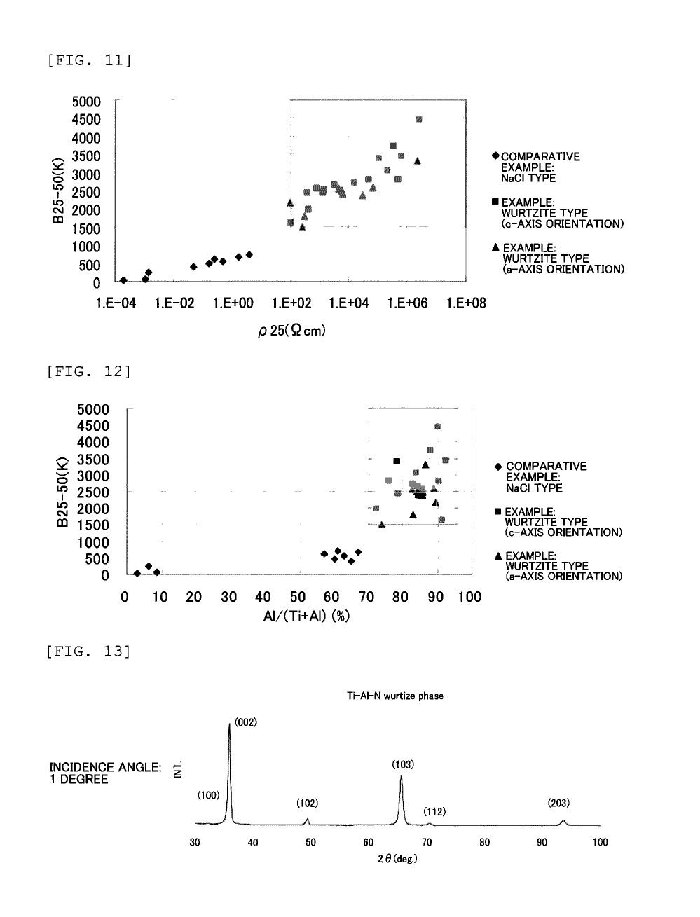

A graph illustrating the relationship between a resistivity at 25° C. and a B constant from the above results is shown in FIG. 11. A graph illustrating the relationship between an Al/(Ti+Al) ratio and a B constant is also shown in FIG. 12. Based on these graphs, the film evaluation elements 121, for which the composition ratios fall within the region where Al/(Ti+Al) is from 0.7 to 0.95 and N/(Ti+Al+N) is from 0.4 to 0.5 and each crystal system of which is a hexagonal wurtzite-type single phase, have a specific resistance value at a temperature of 25° C. of 100 Ωcm or higher and a B constant of 1500 K or higher, which is the region realizing a high resistance and a high B constant. In data shown in FIG. 12, the reason why the B constant varies with respect to the same Al/(Ti+Al) ratio is because the film evaluation elements 121 have different amounts of nitrogen in their crystals.

In the materials according to Comparative Examples 3 to 12 as shown in Table 1, the composition ratios fall within the region where Al/(Ti+Al)<0.7, and the crystal systems are a cubic NaCl-type. In addition, in the material according to Comparative Example 12 (where Al/(Ti+Al)=0.67), a NaCl-type phase and a wurtzite-type phase coexist. Thus, a material with a composition ratio that falls within a region where Al/(Ti+Al)<0.7 has a specific resistance value at a temperature of 25° C. of less than 100 Ωcm and a B constant of less than 1500 K, which is the region of low resistance and low B constant.

In the materials according to Comparative Examples 1 and 2 shown in Table 1, the composition ratio falls within the region where N/(Ti+Al+N) is less than 40%, that is, the material is in a crystal state where nitridation of metals contained therein is insufficient. The materials according to Comparative Examples 1 and 2 are neither a NaCl-type nor a wurtzite-type and had very poor crystallinity. In addition, it is found that the material according to these Comparative Examples exhibited near-metallic behavior because both the B constant and the resistance value are very small.

(4) Thin Film X-Ray Diffraction (Identification of Crystal Phase)

The crystal phases of the thin film thermistor portions 7 obtained by the reactive sputtering method are identified by Grazing Incidence X-ray Diffraction. The thin film X-ray diffraction is a small angle X-ray diffraction experiment. The measurement is performed under the conditions of a vessel of Cu, the angle of incidence of 1 degree, and 2θ of from 20 to 130 degrees.

As a result of the measurement, a wurtzite-type phase (hexagonal, the same phase as that of AlN) is obtained in the region where Al/(Ti+Al)≧0.7, whereas a NaCl-type phase (cubic, the same phase as that of TiN) is obtained in the region where Al/(Ti+AI)<0.65. In addition, a crystal phase in which a wurtzite-type phase and a NaCl-type phase coexist is obtained in the region where 0.65<Al/(Ti+Al)<0.7.

Thus, in the Ti—Al—N-based material, the region of high resistance and high B constant can be realized by the wurtzite-type phase where Al/(Ti+Al)≧0.7. In the materials according to Examples of the present invention, no impurity phase is confirmed and the crystal structure thereof is a wurtzite-type single phase.

In the material according to Comparative Examples 1 and 2 shown in Table 1, the crystal phase thereof is neither wurtzite-type nor NaCl-type as described above, and thus, could not be identified in the testing. In these Comparative Examples, the peak width of XRD is very large, showing that the materials had very poor crystallinity. It is contemplated that the crystal phase thereof is a metal phase with insufficient nitridation because they exhibited near-metallic behavior from the viewpoint of electric properties.

TABLE 1

| | | | CRYSTAL AXIS | |
|---|---|---|---|---|
| | | | EXHIBITING | |
| | | | STRONG | |
| | | | DEGREE OF | |
| | | | ORIENTATION | |
| | | XRD PEAK | IN VERTICAL | |
| | | INTENSITY | DIRECTION WITH | |
| | | RATIO OF | RESPECT TO | |
| | | (100)/(002) | SUBSTRATE | |
| | | WHEN | SURFACE WHEN | |
| | | CRYSTAL | CRYSTAL PHASE | SPUTTERING |
| | | PHASE IS | IS WURTZITE TYPE | GAS |
| | CRYSTAL | WURTZITE | (a-AXIS OR | PRESSURE |
| | SYSTEM | TYPE | c-AXIS) | (Pa) |
| COMPARATIVE | UNKNOWN | — | | — |
| EXAMPLE 1 | (INSUFFICIENT | | | |
| | NITRIDATION) | | | |
| COMPARATIVE | UNKNOWN | — | | — |
| EXAMPLE 2 | (INSUFFICIENT | | | |
| | NITRIDATION) | | | |
| COMPARATIVE | NaCl TYPE | — | | — |
| EXAMPLE 3 | | | | |
| COMPARATIVE | NaCl TYPE | — | | — |
| EXAMPLE 4 | | | | |
| COMPARATIVE | NaCl TYPE | — | | — |
| EXAMPLE 5 | | | | |
| COMPARATIVE | NaCl TYPE | — | | — |
| EXAMPLE 6 | | | | |
| COMPARATIVE | NaCl TYPE | — | | — |
| EXAMPLE 7 | | | | |
| COMPARATIVE | NaCl TYPE | — | | — |
| EXAMPLE 8 | | | | |
| COMPARATIVE | NaCl TYPE | — | | — |
| EXAMPLE 9 | | | | |
| COMPARATIVE | NaCl TYPE | — | | — |
| EXAMPLE 10 | | | | |
| COMPARATIVE | NaCl TYPE | — | | — |
| EXAMPLE 11 | | | | |
| COMPARATIVE | NaCl TYPE + | — | | — |
| EXAMPLE 12 | WURTZITE TYPE | | | |
| EXAMPLE 1 | WURTZITE TYPE | 0.05 | c-AXIS | <0.67 |
| EXAMPLE 2 | WURTZITE TYPE | 0.07 | c-AXIS | <0.67 |
| EXAMPLE 3 | WURTZITE TYPE | 0.45 | c-AXIS | <0.67 |
| EXAMPLE 4 | WURTZITE TYPE | <0.01 | c-AXIS | <0.67 |
| EXAMPLE 5 | WURTZITE TYPE | 0.34 | c-AXIS | <0.67 |
| EXAMPLE 6 | WURTZITE TYPE | <0.01 | c-AXIS | <0.67 |
| EXAMPLE 7 | WURTZITE TYPE | 0.09 | c-AXIS | <0.67 |
| EXAMPLE 8 | WURTZITE TYPE | 0.05 | c-AXIS | <0.67 |
| EXAMPLE 9 | WURTZITE TYPE | <0.01 | c-AXIS | <0.67 |
| EXAMPLE 10 | WURTZITE TYPE | 0.04 | c-AXIS | <0.67 |
| EXAMPLE 11 | WURTZITE TYPE | 0.24 | c-AXIS | <0.67 |
| EXAMPLE 12 | WURTZITE TYPE | 0.73 | c-AXIS | <0.67 |
| EXAMPLE 13 | WURTZITE TYPE | <0.01 | c-AXIS | <0.67 |
| EXAMPLE 14 | WURTZITE TYPE | 0.38 | c-AXIS | <0.67 |
| EXAMPLE 15 | WURTZITE TYPE | 0.13 | c-AXIS | <0.67 |
| EXAMPLE 16 | WURTZITE TYPE | 3.54 | a-AXIS | ≧0.67 |
| EXAMPLE 17 | WURTZITE TYPE | 2.94 | a-AXIS | ≧0.67 |
| EXAMPLE 18 | WURTZITE TYPE | 1.05 | a-AXIS | ≧0.67 |
| EXAMPLE 19 | WURTZITE TYPE | 2.50 | a-AXIS | ≧0.67 |
| EXAMPLE 20 | WURTZITE TYPE | 9.09 | a-AXIS | ≧0.67 |
| EXAMPLE 21 | WURTZITE TYPE | 6.67 | a-AXIS | ≧0.67 |
| EXAMPLE 22 | WURTZITE TYPE | 2.22 | a-AXIS | ≧0.67 |
| EXAMPLE 23 | WURTZITE TYPE | 1.21 | a-AXIS | ≧0.67 |
| EXAMPLE 24 | WURTZITE TYPE | 3.33 | a-AXIS | ≧0.67 |

| | | | | | RESULT OF | |
|---|---|---|---|---|---|---|
| | | | | | ELECTRIC PROPERTIES | |
| | | | | | | SPECIFIC |
| | COMPOSITION RATIO | | | | B | RESISTANCE |
| | | | | Al/(Ti + Al) | CONSTANT | VALUE AT |
| | Ti (%) | Al (%) | N (%) | (%) | (K) | 25° C. (Ωcm) |
| COMPARATIVE | 29 | 43 | 28 | 60 | <0 | 2.E−04 |
| EXAMPLE 1 | | | | | | |
| COMPARATIVE | 16 | 54 | 30 | 77 | 25 | 4.E−04 |
| EXAMPLE 2 | | | | | | |
| COMPARATIVE | 50 | 0 | 50 | 0 | <0 | 2.E−05 |
| EXAMPLE 3 | | | | | | |
| COMPARATIVE | 47 | 1 | 52 | 3 | 30 | 2.E−04 |
| EXAMPLE 4 | | | | | | |
| COMPARATIVE | 51 | 3 | 46 | 6 | 248 | 1.E−03 |
| EXAMPLE 5 | | | | | | |
| COMPARATIVE | 50 | 5 | 45 | 9 | 69 | 1.E−03 |
| EXAMPLE 6 | | | | | | |
| COMPARATIVE | 23 | 30 | 47 | 57 | 622 | 3.E−01 |
| EXAMPLE 7 | | | | | | |
| COMPARATIVE | 22 | 33 | 45 | 60 | 477 | 2.E−01 |
| EXAMPLE 8 | | | | | | |
| COMPARATIVE | 21 | 32 | 47 | 61 | 724 | 4.E+00 |
| EXAMPLE 9 | | | | | | |
| COMPARATIVE | 20 | 34 | 46 | 63 | 564 | 5.E−01 |
| EXAMPLE 10 | | | | | | |
| COMPARATIVE | 19 | 35 | 46 | 65 | 402 | 5.E−02 |
| EXAMPLE 11 | | | | | | |
| COMPARATIVE | 18 | 37 | 45 | 67 | 685 | 2.E+00 |
| EXAMPLE 12 | | | | | | |
| EXAMPLE 1 | 15 | 38 | 47 | 72 | 1980 | 4.E+02 |
| EXAMPLE 2 | 12 | 38 | 50 | 76 | 2798 | 6.E+04 |
| EXAMPLE 3 | 11 | 42 | 47 | 79 | 3385 | 1.E+05 |
| EXAMPLE 4 | 11 | 41 | 48 | 79 | 2437 | 4.E+02 |
| EXAMPLE 5 | 9 | 43 | 48 | 83 | 2727 | 2.E+04 |
| EXAMPLE 6 | 8 | 42 | 50 | 84 | 3057 | 2.E+05 |
| EXAMPLE 7 | 8 | 44 | 48 | 84 | 2685 | 3.E+03 |
| EXAMPLE 8 | 8 | 44 | 48 | 85 | 2527 | 1.E+03 |
| EXAMPLE 9 | 8 | 45 | 47 | 88 | 2557 | 8.E+02 |
| EXAMPLE 10 | 7 | 46 | 46 | 86 | 2449 | 1.E+03 |
| EXAMPLE 11 | 7 | 48 | 45 | 88 | 3729 | 4.E+05 |
| EXAMPLE 12 | 5 | 49 | 46 | 90 | 2798 | 5.E+05 |
| EXAMPLE 13 | 5 | 45 | 50 | 90 | 4449 | 3.E+06 |
| EXAMPLE 14 | 5 | 50 | 45 | 91 | 1621 | 1.E+02 |
| EXAMPLE 15 | 4 | 50 | 46 | 93 | 3439 | 6.E+05 |
| EXAMPLE 16 | 15 | 43 | 42 | 74 | 1507 | 3.E+02 |
| EXAMPLE 17 | 10 | 49 | 41 | 83 | 1794 | 3.E+02 |
| EXAMPLE 18 | 6 | 52 | 42 | 90 | 2164 | 1.E+02 |
| EXAMPLE 19 | 9 | 44 | 47 | 83 | 2571 | 5.E+03 |
| EXAMPLE 20 | 8 | 46 | 46 | 84 | 2501 | 6.E+03 |
| EXAMPLE 21 | 8 | 45 | 47 | 84 | 2408 | 7.E+03 |
| EXAMPLE 22 | 8 | 46 | 46 | 86 | 2364 | 3.E+04 |
| EXAMPLE 23 | 7 | 46 | 47 | 87 | 3317 | 2.E+08 |
| EXAMPLE 24 | 6 | 51 | 43 | 89 | 2599 | 7.E+04 |

Next, since all the materials according to the Examples of the present invention are wurtzite-type phase films having a strong orientation, whether the films have a strong a-axis orientation or c-axis orientation of the crystal axis in a vertical direction (film thickness direction) with respect to the Si substrate S is examined by XRD. At this time, in order to examine the orientation of the crystal axis, the peak intensity ratio of (100)/(002) is measured, where (100) is the Miller index indicating a-axis orientation and (002) is the Miller index indicating c-axis orientation.

As a result of the measurement, in the Examples in which film deposition is performed at a sputtering gas pressure of less than 0.67 Pa, the intensity of (002) is much stronger than that of (100), that is, the films exhibited stronger c-axis orientation than a-axis orientation. On the other hand, in the Examples in which film deposition is performed at a sputtering gas pressure of 0.67 Pa or higher, the intensity of (100) is much stronger than that of (002), that is, the films exhibited stronger a-axis orientation than c-axis orientation.

Note that it is confirmed that a wurtzite-type single phase is formed in the same manner even when the thin film thermistor portion 7 is deposited on a polyimide film under the same deposition condition. It is also confirmed that the crystal orientation did not change even when the thin film thermistor portion 7 is deposited on a polyimide film under the same deposition condition.

An Exemplary XRD profile of the material according to the Example exhibiting strong c-axis orientation is shown in FIG. 13. In this Example, Al/(Ti+Al) is equal to 0.84 (wurtzite-type, hexagonal), and the measurement is performed at 1 degree angle of incidence. As can be seen from the result, the intensity of (002) is much stronger than that of (100) in this Example.

An Exemplary XRD profile of the material according to the Example exhibiting a strong a-axis orientation is also shown in FIG. 14. In this Example, Al/(Ti+Al) is equal to 0.83 (wurtzite-type, hexagonal), and the measurement is performed at a 1 degree angle of incidence. As can be seen from the result, the intensity of (100) is much stronger than that of (002) in this Example.

Furthermore, a symmetrical reflection measurement is performed at a 0 degree angle of incidence. The asterisk (*) in the graphs shows the peak originating from the device, and thus, it is confirmed that the peak with the asterisk (*) in the graphs is neither the peak originating from a sample itself nor the peak originating from an impurity phase (it can be seen that the peak indicated by (*) is the peak originating from the device because it is lost in the symmetrical reflection measurement).

An exemplary XRD profile in the Comparative Example is shown in FIG. 15. In this Comparative Example, Al/(Ti+Al) is equal to 0.6 (NaCl type, cubic), and the measurement is performed at 1 degree angle of incidence. No peak which could be indexed as a wurtzite-type (space group: P6₃mc (No. 186)) is detected, and thus, the film according to this Comparative Example is confirmed as a NaCl-type single phase.

Next, the correlations between a crystal structure and its electric properties are further compared with each other in detail regarding the Examples of the present invention in which the wurtzite-type materials are employed.

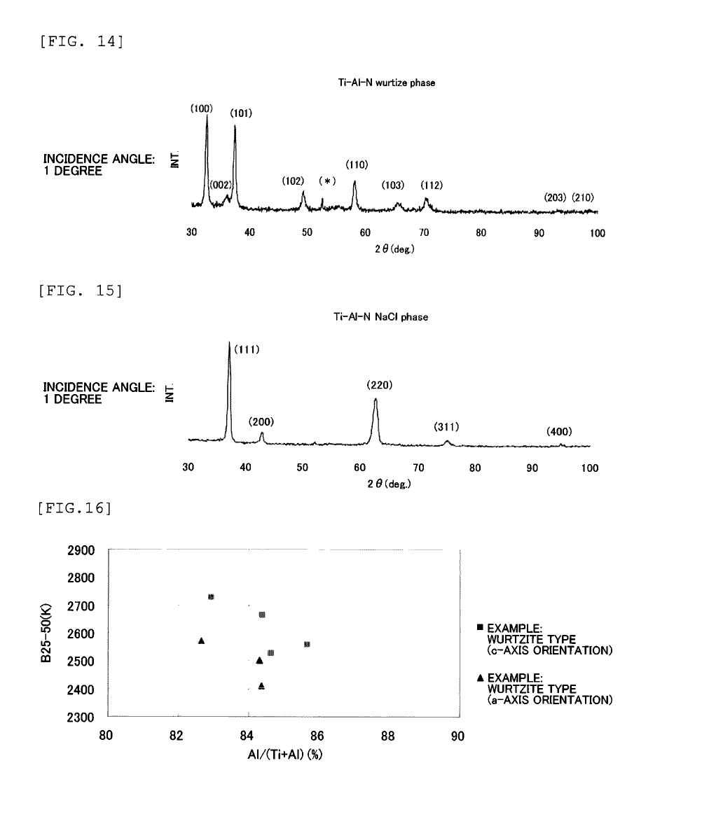

As shown in Table 2 and FIG. 16, the crystal axis of some materials (Examples 5, 7, 8, and 9) is strongly oriented along a c-axis in a vertical direction with respect to the surface of the substrate and that of other materials (Examples 19, 20, and 21) is strongly oriented along an a-axis in a vertical direction with respect to the surface of the substrate among the materials having nearly the same Al/(Ti+Al) ratio.

When both groups are compared to each other, it is found that the materials having a strong c-axis orientation had a higher B constant by about 100 K than that of the materials having a strong a-axis orientation provided that they have the same Al/(Ti+Al) ratio. When focus is placed on the amount of N (i.e., N/(Ti+Al+N)), it is found that the materials having a strong c-axis orientation had a slightly larger amount of nitrogen than that of the materials having a strong a-axis orientation. Since the ideal stoichiometric ratio of N/(Ti+Al+N) is 0.5, it is found that the materials having a strong c-axis orientation are ideal materials due to a small amount of nitrogen defects.

TABLE 2

| | | | CRYSTAL AXIS | | | | | | | |
|---|---|---|---|---|---|---|---|---|---|---|
| | | | EXHIBITING | | | | | | | |
| | | | STRONG | | | | | | | |
| | | | DEGREE OF | | | | | | | |
| | | | ORIENTATION | | | | | | | |
| | | | IN VERTICAL | | | | | | | |
| | | XRD PEAK | DIRECTION | | | | | | | |
| | | INTENSITY | WITH RESPECT | | | | | | | |
| | | RATIO OF | TO SUBSTRATE | | | | | | | |
| | | (100)/(002) | SURFACE WHEN | | | | | | RESULT OF ELECTRIC | |
| | | WHEN | CRYSTAL | | | | | | PROPERTIES | |
| | | CRYSTAL | PHASE IS | SPUTTERING | | | | | | SPECIFIC |
| | | PHASE IS | WURTZITE TYPE | GAS | COMPOSITION RATIO | | | | B | RESISTANCE |
| | CRYSTAL | WURTZITE | (a-AXIS | PRESSURE | | | | Al/(Ti + Al) | CONSTANT | VALUE AT |
| | SYSTEM | TYPE | OR c-AXIS) | (Pa) | Ti (%) | Al (%) | N (%) | (%) | (K) | 25° C. (Ωcm) |
| EXAM- | WURTZITE | 0.34 | c-AXIS | <0.67 | 9 | 43 | 48 | 83 | 2727 | 2.E+04 |
| PLE 5 | TYPE | | | | | | | | | |
| EXAM- | WURTZITE | 0.09 | c-AXIS | <0.67 | 8 | 44 | 48 | 84 | 2665 | 3.E+03 |
| PLE 7 | TYPE | | | | | | | | | |
| EXAM- | WURTZITE | 0.05 | c-AXIS | <0.67 | 8 | 44 | 48 | 85 | 2527 | 1.E+03 |
| PLE 8 | TYPE | | | | | | | | | |
| EXAM- | WURTZITE | <0.01 | c-AXIS | <0.67 | 8 | 45 | 47 | 86 | 2557 | 8.E+02 |
| PLE 9 | TYPE | | | | | | | | | |
| EXAM- | WURTZITE | 2.50 | a-AXIS | ≧0.67 | 9 | 44 | 47 | 83 | 2571 | 5.E+03 |
| PLE 19 | TYPE | | | | | | | | | |
| EXAM- | WURTZITE | 9.09 | a-AXIS | ≧0.67 | 8 | 46 | 46 | 84 | 2501 | 6.E+03 |
| PLE 20 | TYPE | | | | | | | | | |
| EXAM- | WURTZITE | 6.67 | a-AXIS | ≧0.67 | 8 | 45 | 47 | 84 | 2408 | 7.E+03 |
| PLE 21 | TYPE | | | | | | | | | |

### <Crystal Form Evaluation>

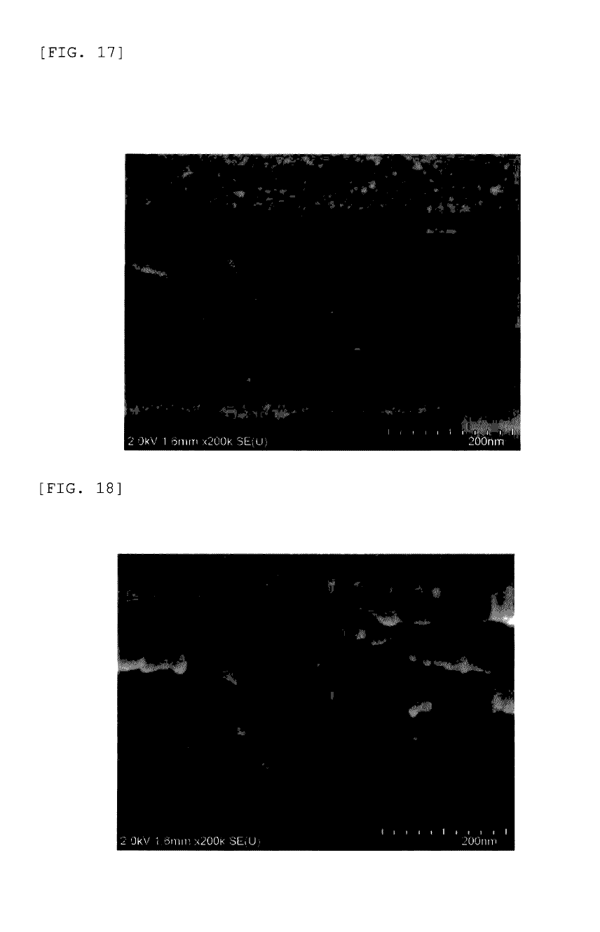

Next, as an exemplary crystal form in the cross-section of the thin film thermistor portion 7, a cross-sectional SEM photograph of the thin film thermistor portion 7 according to the Example (where Al/(Ti+Ai)=0.84, wurtzite-type, hexagonal, and strong c-axis orientation), in which the thin film thermistor portion 7 is deposited on the Si substrate S with a thermal oxidation film, is shown in FIG. 17. In addition, a cross-sectional SEM photograph of the thin film thermistor portion 7 according to another Example (where Al/(Ti+A)=0.83, wurtzite-type, hexagonal, and strong a-axis orientation) is shown in FIG. 18.

The samples in these Examples are obtained by breaking the Si substrates S by cleavage. The photographs are taken by tilt observation at an angle of 45 degrees.

As can be seen from these photographs, the samples are formed of a high-density columnar crystal in both Examples. Specifically, the growth of columnar crystals in a vertical direction with respect to the surface of the substrate is observed both in the Example revealing a strong c-axis orientation and in the Example revealing a strong a-axis orientation. Note that the break of the columnar crystal is generated upon breaking the Si substrate S by cleavage.

### <Heat Resistance Test Evaluation of Film>

For the thin film thermistor portions 7 according to the Examples and the Comparative Examples shown in Table 1, a resistance value and a B constant before and after the heat resistance test at a temperature of 125° C. for 1000 hours in air are evaluated. The results are shown in Table 3. The thin film thermistor portion 7 according to the Comparative Example made of a conventional Ta—Al—N-based material is also evaluated in the same manner for comparison.

As can be seen from these results, although the Al concentration and the nitrogen concentration vary, the heat resistance of the Ti—Al—N-based material based on the change of electric properties before and after the heat resistance test is more excellent than that of the Ta—Al—N-based material according to the Comparative Example when the comparison is made by using the same B constant. Note that the materials according to Examples 5 and 8 have a strong c-axis orientation, and the materials according to Examples 21 and 24 have a strong a-axis orientation. When both groups are compared to each other, the heat resistance of the materials according to the Examples exhibiting a strong c-axis orientation is slightly improved as compared with that of the materials according to the Examples exhibiting a strong a-axis orientation.

Note that, in the Ta—Al—N-based material, the ionic radius of Ta is very large compared to that of Ti and Al, and thus, a wurtzite-type phase cannot be produced in the high-concentration Al region. It is contemplated that the Ti—Al—N-based material having a wurtzite-type phase has a better heat resistance than the Ta—Al—N-based material because the Ta—Al—N-based material is not a wurtzite-type phase.

TABLE 3

| | | | | | | | | RISING RATE OF | |
|---|---|---|---|---|---|---|---|---|---|
| | | | | | | | | SPECIFIC | |
| | | | | | | | | RESISTANCE AT | |
| | | | | | | | | 25° C. AFTER | |
| | | | | | | | | HEAT | RISING RATE OF |
| | | | | | | | SPECIFIC | RESISTANCE | B CONSTANT AFTER |
| | | | | | | | RESISTANCE | TEST | HEAT RESISTANCE |
| | M | | | | Al/(M + Al) | B25-50 | VALUE AT | AT 125° C. FOR | TEST AT 125° C. FOR |
| | ELEMENT | M (%) | Al (%) | N (%) | (%) | (K) | 25° C. (Ωcm) | 1,000 HOURS (%) | 1,000 HOURS (%) |
| COMPARATIVE | Ta | 60 | 1 | 39 | 2 | 2671 | 5.E+02 | 25 | 16 |
| EXAMPLE | | | | | | | | | |
| EXAMPLE 5 | Ti | 9 | 43 | 48 | 83 | 2727 | 2.E+04 | <4 | <1 |
| EXAMPLE 8 | Ti | 8 | 44 | 48 | 85 | 2527 | 1.E+03 | <4 | <1 |
| EXAMPLE 21 | Ti | 8 | 45 | 47 | 84 | 2408 | 7.E+03 | <5 | <1 |
| EXAMPLE 24 | Ti | 6 | 51 | 43 | 89 | 2599 | 7.E+04 | <5 | <1 |

The technical scope of the present invention is not limited to the aforementioned embodiments and Examples, but the present invention may be modified in various ways without departing from the scope or teaching of the present invention.

For example, in the above-described embodiments, although the comb portions are formed on the thin film thermistor portion, the comb portions may be formed under the thin film thermistor portion (on the surface of the insulating film).

### REFERENCE NUMERALS

1: temperature sensor, 2A, 2B: lead frames, 2a: main lead portion, 2b: base-end-side bonding portion, 2c: front-end-side bonding portion, 3: sensor portion, 4: holding portion, 6: insulating film, 7: thin film thermistor portion, 8: comb shaped electrode, 8a: comb portion, 9: pattern electrode, 10: protective film, 11: protective sheet

What is claimed is:

1. A temperature sensor comprising:
a pair of lead frames;
a sensor portion connected to the pair of lead frames; and
an insulating holding portion that is fixed to the pair of lead frames for holding the same,
wherein the sensor portion includes an insulating film in a band shape, a thin film thermistor portion that is patterned on a surface of the insulating film using a thermistor material, a pair of comb shaped electrodes that has a plurality of comb portions at least either on or under the thin film thermistor portion and is patterned so as to be opposed to each other, and a pair of pattern electrodes that is patterned on the surface of the insulating film with one end thereof being connected to the pair of comb shaped electrodes and the other end thereof being connected to the pair of lead frames,
wherein the lead frame has a main lead portion extending along the insulating film and a base-end-side bonding portion that extends from the base end side of the main lead portion to the base end of the insulating film so as to bond to the base end, and
wherein only one of the pair of lead frames has a front-end-side bonding portion that extends from the front end side of the main lead portion to the front end of the insulating film so as to bond to the front end.

2. The temperature sensor according to claim 1, wherein the base-end-side bonding portion is housed in the holding portion.

3. The temperature sensor according to claim 1, further comprising:
a pair of insulating protective sheets that is adhered to the front and back surfaces of the insulating film while covering the pair of lead frames.

4. The temperature sensor according to claim 1, wherein the thin film thermistor portion is arranged near the front end of the insulating film,
wherein the pattern electrodes extend to the vicinity of the base end of the insulating film, and
wherein the base-end-side bonding portions of the pair of lead frames are connected to the pattern electrodes near the base end of the insulating film.

5. The temperature sensor according to claim 1, wherein the thin film thermistor portion is made of a material consisting of a metal nitride represented by the general formula: TiₓAl_{y}N_{z} (where 0.70≦y/(x+y)≦0.95, 0.4≦z≦0.5, and x+y+z=1), wherein the crystal structure thereof is a hexagonal wurtzite-type single phase.
